(19) United States
(12) Patent Application Publication
(10) Pub. No.: US 2010/0100723 A1
(43) Pub. Date: Apr. 22, 2010

(54) SERVICE APPLICATION PLATFORM AND METHOD FOR ACCESSING SERVICE APPLICATION PLATFORM

(75) Inventors: Caishi Yang, Shenzhen City (CN); Min Yan, Shenzhen City (CN); Shaohua Chen, Shenzhen City (CN)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: Tencent Technology (Shenzhen) Company Ltd., Shenzhen (CN)

(21) Appl. No.: 12/647,605

(22) Filed: Dec. 28, 2009

Related U.S. Application Data
(63) Continuation of application No. PCT/CN2008/007064, filed on Mar. 31, 2008.

(30) Foreign Application Priority Data
Jul. 13, 2007 (CN) 200710118792.2

(51) Int. Cl. G06F 15/16; H04L 29/06

(52) U.S. Cl. 713/150; 709/203

(57) ABSTRACT

This invention provides a service application platform and a method for accessing a service application platform. The service application platform includes: a processing interface, adapted to send a service request to a service application client; the service application client, adapted to receive the service request sent from the processing interface, and to send the service request to a server; and the server, adapted to process the service request, and to provide a user with requested information.

This application is a continuation of PCT/CN2008/070646 filed Mar. 31, 2008, which claims priority to Chinese Patent Application No. 200710118792.2 filed Jul. 13, 2007, the contents of both are incorporated herein by reference as if reproduced in their entirety.

### FIELD OF THE INVENTION

The present invention relates to service application technologies, and in particular to a service application platform and a method for accessing a service application platform.

### BACKGROUND OF THE INVENTION

At present, the technique for accessing a service application platform is implemented based on a service application client, e.g. an online game client (such as a game hall), an online music client, an online video client, etc. In the prior art, a user accesses the service application platform in a process as follows.

Step 101: The user starts the service application client, and initiates a service request to a service application server through the service application client, i.e. requests using a service application function provided by the service application platform, for example, requests querying service state information of a certain user or requests accessing a certain service instance, and so on. If the service application platform is an online game platform, the user may request querying the game state information of a certain player (i.e. a registered user of the online game platform), or alternatively may request accessing a certain online game scene, and so on. Here, the user initiating the request belongs to an active user group of the service application platform, i.e. is a registered user of the service application platform. The service application platform is a collection of a series of devices which provide service application functions for the user, and may include the service application client and the service application server (denoted as server hereinbelow).

Step 102: The user receives the service state information of another user of the service application platform in a service instance through the service application client. The service state information may be the user's specific location, state and the like in the service instance, e.g. the server, the game, the game scene, the current game state of the user in the online game, or the music that the user is listening to or the video that the user is watching in the online entertainment platform, etc.

Step 103: The user selects a second user according to the service state information received, and accesses the service instance through the service application client, e.g. reaches the specific location that the second user is located in the service application, and may also perform service interaction with the second user, e.g. participates the same game and so on, or listens to the music that the second user is listening to, or watches the video that the second user is watching, etc. The online game platform is taken as an example. Regarding the user's experience, the specific location of the second user is represented as the game that the second user is participating in and the second user's location in the game, e.g. a certain room and a certain table, etc. With respect to the game platform, the game environment that the second user is located is technically presented by a set constituted by a series of parameters.

Along with the development of the Internet, a new requirement arises as follows. Not only the service application client itself can provide the function of accessing the service application platform, but also various platforms can be provided with an entry (which may also be called an interface) so as to implement the function of accessing the service application platform. For example, the interface for implementing the function is provided on the community web page of a forum for the user of the forum. Meanwhile, the function should be extensible, so as to facilitate the incorporation with a future partner, e.g. to add and provide the function in the web page of the future partner (i.e. the third party), thus implementing the interaction between the service application client and the future partner (e.g. the web page). However, such a new requirement can not be met due to the disadvantage of the prior art.

The disadvantage of the prior art is as follows. The user can access the service application platform only through the service application client.

### SUMMARY OF THE INVENTION

In view of the above, a main object of the present invention is to provide a service application platform, which can provide an interface for various platforms so as to implement the function of accessing the service application platform.

Another object of the present invention is to provide a method for accessing a service application platform, which can provide an interface for various platforms so as to implement the function of accessing the service application platform, e.g. to make the user to access the online game platform through the interface, and so on.

To achieve the above objects, the present invention provides technical solutions as follows.

A service application platform, which includes:
a processing interface, adapted to send a service request to a service application client;
the service application client, adapted to receive the service request sent from the processing interface, and to send the service request to a server; and
the server, adapted to process the service request, and to provide a user with requested information.

A method for accessing a service application platform, which includes:
sending a service request to a service application client, by a processing interface;
receiving the service request from the processing interface, and sending the service request to a server, by the service application client; and
processing the service request, and providing a user with requested information, by the server.

The service application platform and the method proposed by the present invention can provide an interface for various platforms so as to implement the function of accessing the service application platform.

According to the preferred embodiment of the present invention, the web page acting as the third-party client is taken as an example. Because the user may interact with the service application client through the web page, the user surfing the web page (i.e. the passive user of the service application platform) may access the service application platform through the service application client easily by way of such interaction, e.g. may query the service state information including the specific location that the second user is located in the service instance. Meanwhile, the service application client may send the query result to a processing interface or send it to the third-party client through the processing interface, where the processing interface or the third-party client performs a display, i.e. a presentation as a web page result. The service application client may also present the query result to the user in the form of a client interface, i.e. a presentation as a non-web-page result. The user may select the second user according to the query result, and access the service instance that the second user is located, e.g. the specific location that the second user is located in the service instance, and may also perform service interaction with the second user, e.g. play a game with the second user and so on. Therefore, such a way of interaction not only greatly improves the interaction between the service application platform and the third-party platform, but also helps extending the user group.

To sum up, the method of the prior art that the user accesses the service application platform directly through the service application client provides merely simple functions. However, the user can access the service application platform easily through the interface provided by the present invention.

The preferred embodiment of the present invention may take a larger amount of users of the third-party clients as the key point, thus facilitating the extension of the user group.

### BRIEF DESCRIPTION OF THE DRAWINGS

FIG. 1 is a schematic diagram illustrating a structure of a service application platform according to an embodiment of the present invention.

FIG. 2 is a schematic diagram illustrating the structure of the service application platform according to another embodiment of the present invention.

FIG. 3 is a flowchart illustrating a method for accessing a service application platform according to an embodiment of the present invention.

FIG. 4 is a flowchart illustrating the method for accessing a service application platform according to another embodiment of the present invention.

### DETAILED DESCRIPTION OF THE EMBODIMENTS

The core idea of the present invention is as follows. Firstly, a processing interface is added between the third-party client and the service application client, where the user accesses the service application platform through the processing interface. Specifically, the service application platform may be a platform of online game, online music, and online video, etc. The processing interface may be implemented in various ways. For example, if the third-party client is a web page, the processing interface may be a web page control or an ActiveX control or the like established by the web page.

According to an embodiment of the present invention, the third-party client selects the second user according to the service state information (which is sent from or displayed by the processing interface and is returned from the service application client) which includes the specific location that at least one user is located in the service application, then initiates a request used for accessing the service application to the service application client through the processing interface, reaches the specific location that the second user is located in the service instance, and uses the service application (e.g. plays the game with the second user, and so on). Certainly, the service state information may alternatively be displayed by the service application client, or be sent to the processing interface for a display, or alternatively the processing interface may send the service state information to the third-party client and the third-party client performs the display.

For better understanding of the objects, technical solutions and advantages of the present invention, the present invention is described in more detail hereinbelow with reference to the accompanying drawings and the embodiments.

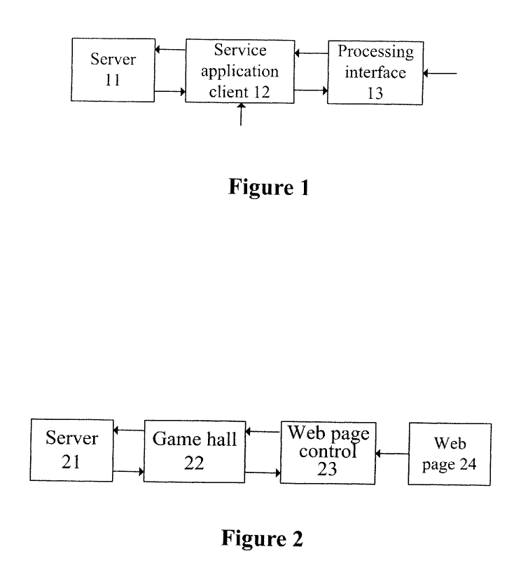

FIG. 1 is a schematic diagram illustrating a structure of a service application platform. The platform includes a processing interface 13, a service application client 12 and a server 11. Specifically, the processing interface 13 is adapted to send a service request to the service application client 12 according to an instruction from a user; the service application client 12 is adapted to send the service request sent from the processing interface 13 to the server 11; and the server 11 is adapted to process the message of the service request, and to provide the user with requested information.

FIG. 2 is a schematic diagram illustrating the structure of the service application platform by taking an online game platform as an example. In this embodiment, the user accesses the service application platform through the third-party client (i.e. a web page 24), where the platform includes the web page 24, a web page control 23, a game hall 22 and a server 21, thus implementing the function for the user to access the service application platform through the processing interface.

Specifically, the web page 24, which acts as the third-party client, is adapted to initiate a service request (e.g. a request used for querying the service state of a second user, accessing the service instance that the second user is located, etc.) to the service application client (i.e. the game hall 22) through the processing interface (i.e. the web page control 23) according to an instruction from a user. The web page control 23 is adapted to receive the instruction sent from the third-party client, to generate the service request according to the instruction, and to send the service request to the game hall 22, thus acts as the interface used for establishing a connection between the web page 24 and the game hall 22. The game hall 22 is adapted to receive the service request of the web page 24, to forward the service request to the server 21, and to display the requested information obtained from the server 21, or to return the requested information to the web page control 23, where the web page control 23 performs the display or forwards it to the web page 24. In this way, the function for the user of the third-part client to access the service application platform is implemented, thus facilitating the passive user of the service application platform in accessing the service application platform through various third-party clients, therefore facilitating the extension of the user group of the service application platform. Here, the web page 24, the web page control 23 and the game hall 22 are all located at the client side.

Moreover, the server 21, which is adapted to store the service state information of the second user, is located at the server side.

Based on the schematic diagram illustrating the structure of the service application platform as shown in FIG. 1, the processing interface 13 may further display the service application information from the server 11, e.g. display the service state information of the user of the service application platform randomly, etc. The user may initiate the service request (e.g. query the detailed service state information of a certain user having been displayed, or request accessing a certain service instance having been displayed, etc.) by reviewing the information displayed by the processing interface 13. Hence, the target queried by the user is much more random, thus facilitating the extension of the user group of various service applications, and also facilitating the interworking among the users of different service applications.

The first user may select the second user according to the service state information of other user(s) displayed by the third-party client or the processing interface, and initiate the service request to the service application platform to request accessing the service instance that the second user is located, e.g. to request accessing the specific location that the second user is located in the service application.

Correspondingly, the service application client is further adapted to receive the third-party client's request of accessing the service instance that the second user is located, to forward it to the server, and to implement the operation used for having the first user to access the service instance that the second user is located, thus implementing the function of accessing the service application platform, which may further implement the function for the first user to perform service interaction with the second user of the service application platform, e.g. to participate in the same game, to listen to the same music, to watch the same video, etc. Here, the operation used for having the first user to access the service instance that the second user is located can be implemented in a way as follows: the server sets for the first user the service state information corresponding to the second user according to the service instance and the service state that the second user is in. For example, the online game server sets the service state information of the first user as being located in another seat of the same table in the same room of the same game as the second user.

Moreover, the user's service state information stored in the server includes the user's service environment information in the service instance, e.g. the information of the specific location.

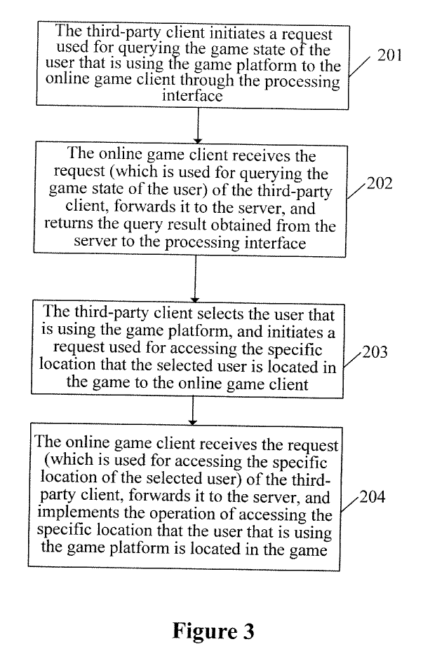

FIG. 3 is a flowchart illustrating a method for accessing a service application platform according to a first embodiment of the present invention.

Step 201: The third-party client initiates a service request to the service application client through the processing interface according to an instruction of the first user. For example, in the case of a request used for querying the service state information of the second user, an identifier (such as an account) of the queried user (i.e. the second user) is encapsulated in the request.

Step 202: The service application client receives the service request of the third-party client, forwards it to the server, and directly displays the requested information obtained from the server. Here, the service application client may alternatively return the requested information to the processing interface, where the processing interface displays the requested information or forwards the requested information to the third-party client for a display.

In the above, the user of the third-party client accesses the service application platform through the interaction between the third-party client and the service application client. Specifically, in the case that the request is used for querying the service state information of the second user, the requested information may refer to the query result, i.e. the service state information of the second user.

For example, the query result may include the service environment parameter used for uniquely determining the service environment that the second user is located in the service instance, e.g. the information of the specific location that the second user is located in the online game service, which may include a server ID, a room ID, a table ID, and a seat ID, etc. The information of the server ID is used for determining the IP address (according to which the first user may establish a connection with the server) of the server that the second user is located. The information of the room ID is used for determining the room that the second user is located, where a server may manage a plurality of rooms. The information of the table ID is used for determining the table that the second user is located, where a room includes a certain number of tables. The information of the seat ID is used for determining the seat that the second user is sitting on, where a table includes a plurality of seats.

The query result may further include an identifier (e.g. game ID information of the service instance and an identifier (e.g. a game state ID, etc.) of the current service state of the user. Specifically, the identifier of the service instance is used for determining the service instance that the second user is located, e.g. the game that the second user participates in. The identifier of the current service state is used for determining the current service state of the second user, e.g. being in a game, being ready but having not begin a game yet, not being ready, etc.

Specifically, before the processing interface initiates the service request to the service application client in Step 201, the following may further be included.

The processing interface checks and determines whether the service application client is installed and started: if so, Step 202 is executed; otherwise, a prompt request is sent to the third-party client, the third-party client is prompted to install and start the client application client, and the current process is terminated.

Step 201 may further include: pre-allocating an encryption key for the processing interface and the service application client, and encrypting the service request exchanged between the third-party client and the service application client.

Before the third-party client initiates the service request to the service application client through the processing interface in Step 201, an authentication operation between the third-party client and the service application platform may further be included.

After Step 202, the following may further be included.

Step 203: The first user selects the second user according to the service state information (which is used for determining that the second user is in the service application) displayed by the third-party client or the processing interface, and initiates a request used for accessing the service instance that the second user is located to the service application client.

Step 204: The service application client receives the request (which is used for accessing the service instance that the second user is located) of the third-party client, forwards it to the server, and implements the operation of accessing the service instance that the second user is located, e.g. allocates the state information corresponding to the second user for the user using the service application client, so that the user of the third-party client may access the service instance that the second user is located.

Step 204 may include: having the user of the third-party client to access the service instance that the second user is located according to the game ID information and the game state ID information.

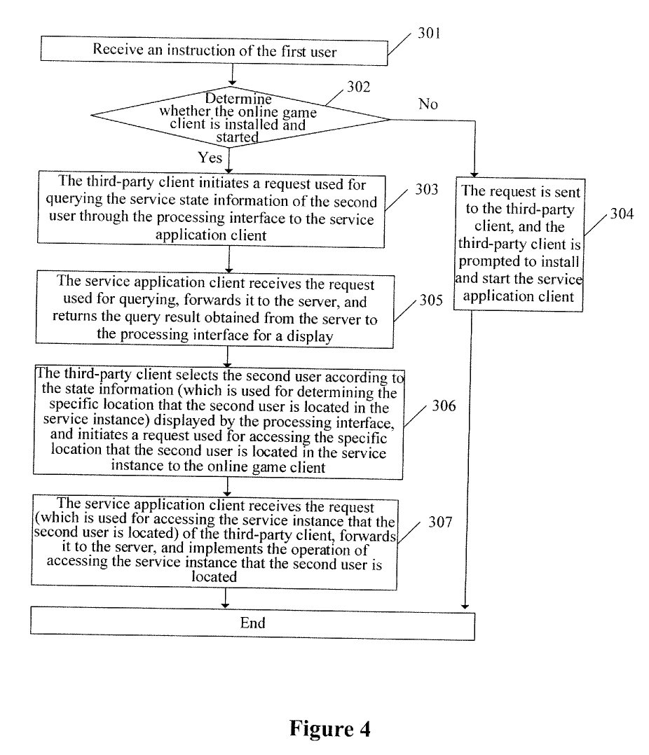

FIG. 4 is a flowchart illustrating the method according to a second embodiment of the present invention. The method for accessing a service application platform includes the following.

Step 301: The processing interface receives an instruction of the first user through the third-party client, e.g. the user clicks the game icon of the second user displayed by the web page control in the web page.

Step 302: The processing interface checks and determines whether the service application client is installed and started, Step 303 is executed if so, and Step 304 is executed otherwise.

Step 303: The third-party client initiates a request used for querying the state information of the second user through the processing interface to the service application client, where an identifier (e.g. an account) of the queried user is encapsulated in the request used for querying the state information of the second user.

Step 304: The request is sent to the third-part client, the third-party client is prompted to install and start the service application client, and the current process is terminated.

Step 305: The service application client receives the request (which is used for querying the state information of the second user) of the third-party client, forwards it to the server, and returns the query result obtained from the server to the processing interface, and the processing interface forwards it to the third-party client.

Step 306: The third-party client selects the second user according to the state information (which is used for determining the specific location that the second user is located in the service instance) sent from the processing interface, and initiates a request used for accessing the specific location that the second user is located in the service instance to the service application client.

Step 307: The service application client receives the request (which is used for accessing the specific location that the selected user is located in the game) of the third-party client, forwards it to the server, and implements the operation of accessing the service instance that the second user is located, e.g. makes the first user to play the game with the second user according to the game ID information and the game state ID information.

The foregoing is merely the preferred embodiments of the present invention, and is not intended to limit the scope of the present invention.

What is claimed is:

1. A service application platform, comprising:
a processing interface, adapted to receive an instruction from a user, so as to send a service request to a service application client;
the service application client, adapted to receive the service request sent from the processing interface, and to send the service request to a server; and
the server, adapted to process the service request, and to provide the user with requested information.

2. The service application platform according to claim 1, further comprising:
a third-party client, adapted to send the instruction of the user to the processing interface.

3. The service application platform according to claim 1, wherein
the processing interface is adapted to send a request used for querying service state information of a second user to the service application client; and
the server is adapted to provide the user with the service state information of the second user.

4. The service application platform according to claim 1, wherein
the processing interface is adapted to send a request used for a first user to access a service instance of a second user to the service application client; and
the server is adapted to set, for the first user, service state information corresponding to the service state information of the second user, and provide the user with the service state information of the first user.

5. The service application platform according to claim 2, wherein
the server is adapted to perform at least one of following: sending the requested information to the service application client, and the service application client is adapted to display the requested information;
sending the requested information to the processing interface through the service application client, and the processing interface is further adapted to display the requested information; and
sending the requested information to the third-party client through the service application client and the processing interface, and the third-party client is further adapted to display the requested information.

6. The service application platform according to claim 2, wherein
the processing interface is further adapted to check and determine whether the service application client is installed and started, and to send a prompt message to the third-party client if the service application client is not installed and started.

7. The service application platform according to claim 1, wherein
the processing interface is further adapted to encrypt the service request using a pre-allocated encryption key; and
the service application client is further adapted to decrypt the service request using the pre-allocated encryption key.

8. The service application platform according to claim 1, wherein
the processing interface is further adapted to perform authentication with the service application client.

9. A method for accessing a service application platform, comprising:
sending a service request to a service application client according to an instruction from a user, by a processing interface;
receiving the service request from the processing interface, and sending the service request to a server, by the service application client; and
processing the service request, and providing the user with requested information, by the server.

10. The method according to claim 9, further comprising:
sending the instruction of the user to the processing interface, by a third-party client.

11. The method according to claim 9, wherein
the service request is used for querying service state information of a second user; and
the requested information is the service state information of the second user.

12. The method according to claim 9, wherein
the service request is used for a first user to access a service instance of a second user; and
the process of processing the service request, and providing the user with requested information, by the server comprises:
setting, for the first user, service state information corresponding to the service state information of the second user, and providing the user with the service state information of the first user, by the server.

13. The method according to claim 12, wherein
the service state information comprises at least one of following: a service environment parameter used for uniquely determining a service environment that the second user is located in a service instance, an identifier of service instance, and an identifier of current service state.

14. The method according to claim 10, wherein the process of providing the user with requested information, by the server comprises at least one of following:
sending the requested information to the service application client, by the server; and displaying the requested information, by the service application client;
sending the requested information to the processing interface through the service application client, by the server; and displaying the requested information, by the processing interface; and
sending the requested information to the third-party client through the service application client and the processing interface, by the server; and displaying the requested information, by the third-party client.

15. The method according to claim 10, further comprising:
checking and determining whether the service application client is installed and started, and sending a prompt message to the third-party client if the service application client is not installed and started, by the processing interface.

16. The method according to claim 9, further comprising:
encrypting the service request using a pre-allocated encryption key, by the processing interface;
decrypting the service request using the pre-allocated encryption key, by the service application client.

17. The method according to claim 9, further comprising:
performing authentication with the service application client, by the processing interface.
